(19) United States
(12) Patent Application Publication
(10) Pub. No.: US 2026/0284448 A1
(43) Pub. Date: Sep. 24, 2026

(54) LIFTING DEVICE

(71) Applicant: Artisans Working At Heights Co., Ltd., Dongguan (CN)

(72) Inventors: Feng ZHANG, Dongguan (CN); Zhiping ZHOU, Dongguan (CN); Long ZHANG, Dongguan (CN)

(21) Appl. No.: 19/677,586

(22) Filed: May 14, 2026

Related U.S. Application Data
(63) Continuation of application No. PCT/CN2024/107294, filed on Jul. 24, 2024.

(30) Foreign Application Priority Data
Dec. 1, 2023 (CN) 202323269954.6

(51) Int. Cl. A62B 1/14

(52) U.S. Cl. CPC A62B 1/14

(57) ABSTRACT

A lifting device is disclosed and includes a base. A cover plate is hinged to a front side of the base through a first shaft, and a gearbox is hinged to a rear side of the base through a second shaft. The gearbox includes a housing, an input shaft is arranged in the housing, and one end of the input shaft extends to an outer side of the housing and includes a drill socket. The input shaft drives a first transmission gear through an input gear coaxially connected thereto, the first transmission gear is coaxially connected with a second transmission gear, the second transmission gear drives an output gear, and the output gear is in transmission connection with an output shaft. The output shaft extends to the outer side of the housing and is connected with a rope wheel, the rope wheel is arranged between the base and the cover plate, and multiple pressure rollers are arranged on the base at one side of the rope wheel.

### CROSS-REFERENCE TO RELATED APPLICATIONS

This application is a United States national stage application of International Patent Application No. PCT/CN 2024/107294, filed Jul. 24, 2024, which claims priority to Chinese Patent Application No. 202323269954.6, filed Dec. 1, 2023, entitled “Lifting Device”. The entire contents of each of the above applications are incorporated herein by reference.

### TECHNICAL FIELD

The present disclosure relates to the technical field of rope lifting, and specifically to a lifting device.

### BACKGROUND

A lifting device is a mechanical apparatus used to conveniently transport personnel or goods vertically between different floors. Such a device may be either manually operated or automated. However, in most manually operated lifting devices, operation tends to be relatively complex, with blind spots and insufficient flexibility. For example, the electric drill drive portion may lack a mechanism to prevent accidental operation, which can pose safety hazards if the operator uses it without noticing the drill's rotation direction. Moreover, many devices are not equipped with an anti-reverse mechanism, or the anti-reverse function is inadequate, thereby increasing the likelihood of safety accidents.

### SUMMARY

To address the above issues, the purpose of the present disclosure is to provide a lifting device that features a function for preventing accidental operation of an electric drill and a dual anti-reverse function. The device is flexible, convenient, safe, and reliable, and has good potential for widespread application.

To achieve the above purpose, the present disclosure provides the following technical solution:

A lifting device, comprising a base, wherein a cover plate is hinged to a front side of the base through a first shaft, and a gearbox is hinged to a rear side of the base through a second shaft; the gearbox comprises a housing, an input shaft is arranged in the housing, one end of the input shaft extends to an outer side of the housing and is provided with a drill socket, the input shaft drives a first transmission gear through an input gear coaxially connected thereto, the first transmission gear is coaxially connected with a second transmission gear, the second transmission gear drives an output gear, and the output gear is in transmission connection with an output shaft, the output shaft extends to the outer side of the housing and is connected to a rope wheel, the rope wheel is arranged between the base and the cover plate, one outer side surface of the cover plate is curved and fits with the base when closed, and M pressure rollers are arranged on the base at one side of the rope wheel;

A limiting piece passing through the base is provided on a side of the gearbox facing the base; an extension piece is provided at an upper end of the gearbox, and the extension piece is provided with a guide slot; the extension piece of the gearbox is connected to a following block and a handle through a fourth shaft, one side surface of the following block is provided with a slider groove and the other side is provided with a handle transmission groove, one end of the first shaft passes through the guide slot and extends into the slider groove, a handle push block is provided on an inner side of the handle facing the following block, and the handle push block is rotatably arranged in the handle transmission groove and drives the following block to rotate along with the handle.

Further, a return torsion spring is arranged in the handle.

Further, a first outer ring is mounted on an outer side of the first shaft through a bearing.

Further, the M pressure rollers are rotatably connected to the base, and a wear-resistant block is provided on the base at one side of the M pressure rollers, where M is an integer greater than or equal to 1.

Further, a spring pin is arranged on the base, and N locking holes through which the spring pin passes are arranged on the cover plate, where N is an integer greater than or equal to 1.

Further, the limiting piece comprises a guide post and a protruding disc arranged at one end of the guide post, and a limiting groove matched with the limiting piece is provided on the base.

Further, the housing of the gearbox comprises a front housing and a rear housing, and the input gear, the first transmission gear, the second transmission gear, and the output gear are all mounted between the front housing and the rear housing.

Further, a one-way ratchet is provided on one side of the output gear, and the one-way ratchet is pressed against the output gear by a spring.

Further, any one of the input gear, the first transmission gear, or the second transmission gear is provided with a one-way bearing.

Further, one end of the output shaft is provided with an anti-reverse device, and the anti-reverse device comprises a centrifugal pin mounted at one end of the output shaft, and a one-way cam plate is provided on an outer side of the centrifugal pin.

The present disclosure has the following beneficial effects:
1. The present disclosure enables electric ascent and manual descent, and is flexible, convenient, safe, and reliable. When electric ascent is required, the handle is in a locked position (as shown in FIG. 1), the rope wheel and the pressure rollers tightly grip both sides of the rope, and an external drill is used for lifting. The output end of the external drill is inserted into the drill socket, and torque is transmitted from the external drill output end sequentially to the input shaft, the first transmission gear, the second transmission gear, the output gear, and the output shaft, and finally to the rope wheel. The rope wheel rotates to drive the lifting device to ascend along the rope, facilitating operation by high-altitude workers. When descent is required, the handle is manually rotated in the reverse direction. During rotation, there is a transition process (during which the rope is still gripped). Continued rotation of the handle causes relative rotation between the base and the gearbox with the second shaft as a hinge point, and the angle between the base and the gearbox gradually increases. At this time, the distance between the rope wheel and the pressure rollers gradually increases, the friction force between the rope and the device gradually decreases, and the gripping force of the lifting device on the rope is gradually released and reduced, thereby achieving controlled descent. The high-altitude worker only needs to control the opening angle of the handle to control the gripping force between the rope and the device;
2. The present disclosure has a function for preventing accidental operation of the external drill. When the output direction of the external drill is incorrect, due to the action of the one-way bearing, the one-way bearing idles, and the torque output by the external drill cannot be transmitted to the output shaft, so that the rope wheel does not rotate. Only when the output direction is correct can the torque of the external drill be transmitted to the rope wheel for lifting operation;
3. In the present disclosure, one outer side surface of the cover plate is designed to be curved and fits with the base when closed, thereby preventing incorrect installation direction of the rope and providing a function for preventing misinstallation of the rope;
4. The anti-reverse device provided in the present disclosure achieves one-way rotation blocking cooperation through the centrifugal pin and the one-way cam plate, effectively preventing reverse rotation of the output shaft and the rope wheel. Meanwhile, the provided one-way ratchet meshes with the output gear so that the output gear can only rotate in one direction and cannot reverse, thereby providing a dual anti-reverse function for the rope wheel.

### BRIEF DESCRIPTION OF DRAWINGS

FIG. 1 is a schematic diagram of an overall structure of the present disclosure.

FIG. 2 is a schematic diagram of an overall structure of another side of the present disclosure.

FIG. 3 is an exploded view of the present disclosure.

FIG. 4 shows the internal structure of the gearbox of the present disclosure.

FIG. 5 is a schematic diagram of the driving of the present disclosure by the external drill.

FIG. 6 is a schematic diagram of the structure of the anti-reverse device of the present disclosure.

FIG. 7 is a schematic diagram of the structure of the rear housing of the present disclosure.

FIG. 8 is a schematic diagram of the structure of the front housing of the present disclosure.

FIG. 9 is a schematic diagram of the structure of the following block of the present disclosure.

FIG. 10 is a schematic diagram of another side structure of the following block of the present disclosure.

FIG. 11 is a schematic diagram of the structure of the handle of the present disclosure.

In the drawings: base 1, pin hole 11, spring pin 12, limiting groove 13, guide channel 14, pressure roller 15, wear-resistant block 16, main hole 17, auxiliary hole 18, cover plate 2, locking hole 21, gearbox 3, front housing 31, extension piece 311, guide slot 3111, following block 312, slider groove 3121, handle transmission groove 3122, handle 313, handle push block 3131, rear housing 32, second spring hole 321, input shaft 4, drill socket 41, input gear 42, transmission shaft 5, first transmission gear 51, one-way bearing 511, second transmission gear 52, output shaft 6, output gear 61, rope wheel 62, anti-reverse device 63, centrifugal pin 631, one-way cam plate 632, reverse locking notch 6321, ratchet shaft 7, one-way ratchet 71, meshing portion 711, first spring hole 712, limiting piece 8, first shaft 100, first outer ring 1001, second shaft 200, fourth shaft 400, external drill 500, rope 600.

### DETAILED DESCRIPTION OF EMBODIMENTS

The technical solutions in the embodiments of the present disclosure will be clearly and completely described below with reference to the accompanying drawings. Apparently, the described embodiments are only a part of the embodiments of the present disclosure, rather than all of the embodiments. Based on the embodiments of the present disclosure, all other embodiments obtained by a person of ordinary skill in the art without making any inventive effort shall fall within the protection scope of the present disclosure.

The specific embodiments of the present disclosure will be described in detail below with reference to the accompanying drawings. It should be understood that the specific embodiments described herein are only for illustrating and explaining the present disclosure, and are not intended to limit the present disclosure.

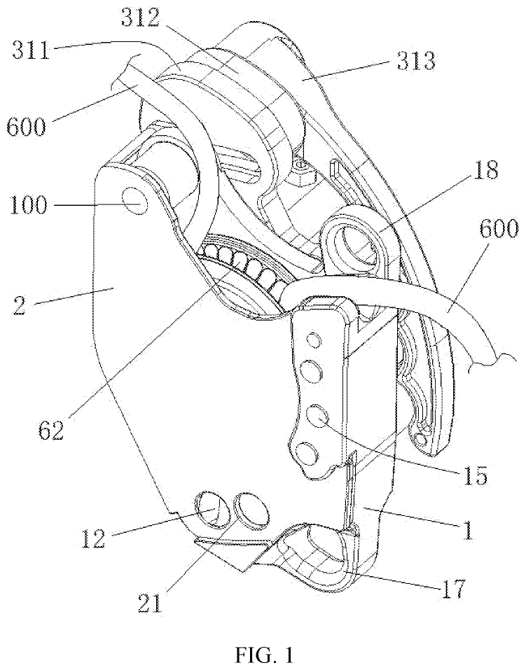

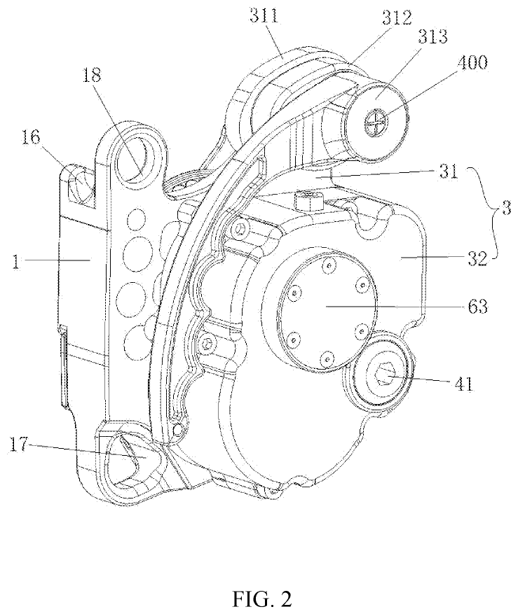

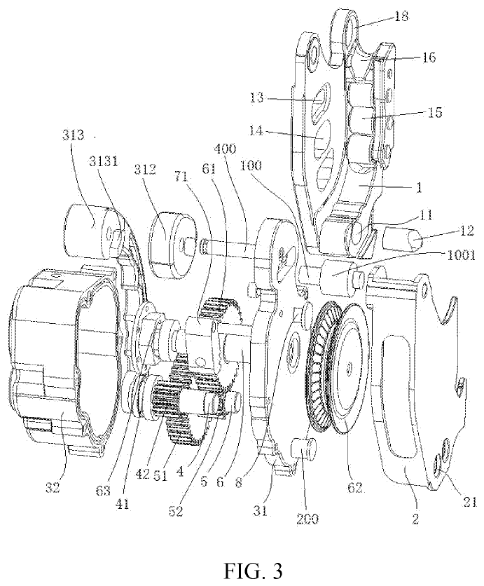

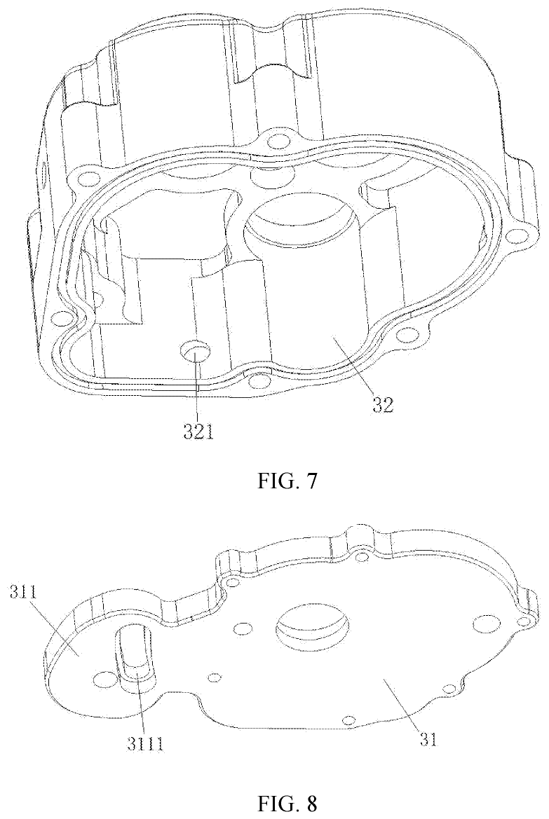

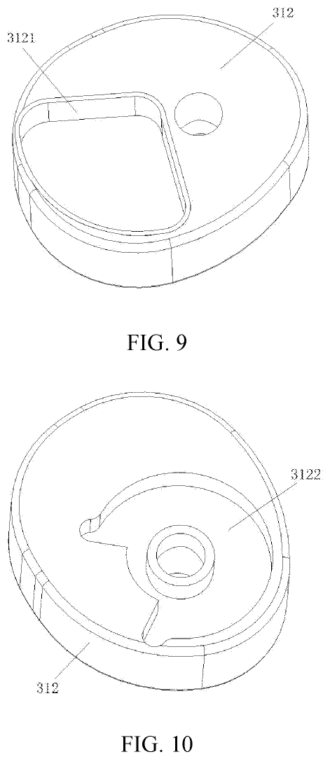

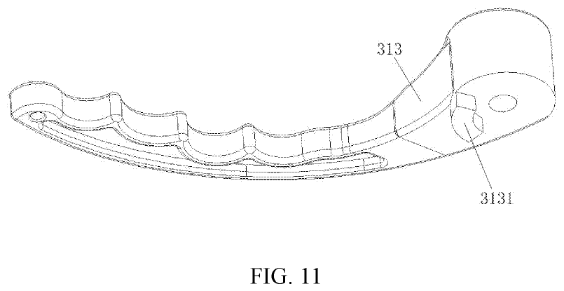

As shown in FIGS. 1-11, a lifting device comprises a base 1. A cover plate 2 is hinged to a front side of the base 1 through a first shaft 100, and a gearbox 3 is hinged to a rear side of the base 1 through a second shaft 200. The gearbox 3 comprises a housing, which includes a front housing 31 and a rear housing 32. The front housing 31 and the rear housing 32 are fastened together by fasteners. An input shaft 4, a transmission shaft 5, an output shaft 6, and a ratchet shaft 7 are mounted between the front housing 31 and the rear housing 32. An input gear 42 is sleeved on the input shaft 4. A first transmission gear 51 and a second transmission gear 52 are sequentially sleeved on the transmission shaft 5 from rear to front. An output gear 61 is sleeved on the output shaft 6, and a one-way ratchet 71 is sleeved on the ratchet shaft 7. The input gear 42 is in transmission connection with the first transmission gear 51, the first transmission gear 51 is coaxially connected with the second transmission gear 52, the second transmission gear 52 is in transmission connection with the output gear 61, and the output gear 61 meshes with the one-way ratchet 71.

One end of the input shaft 4 extends to the outside of the rear housing 32 and is provided with a drill socket 41. One end of the output shaft 6 extends to the outside of the front housing 31 and is connected with a rope wheel 62, on which a rope 600 is sleeved. Through rotational cooperation between the drill socket 41 and an external drill 500 (as indicated by the arrow in FIG. 5 showing the rotation direction of the external drill 500), the input gear 42 sleeved on the input shaft 4 is driven. The input gear 42 drives the first transmission gear 51 to rotate, the first transmission gear 51 drives the coaxial second transmission gear 52 to rotate, the second transmission gear 52 drives the output gear 61 to rotate, and the output gear 61 drives the rope wheel 62 on the output shaft 6 to rotate, thereby lifting the rope 600.

The input gear 42, the first transmission gear 51, and the second transmission gear 52 are provided with one-way bearings 511. In this embodiment, a one-way bearing 511 is further sleeved between the first transmission gear 51 and the transmission shaft 5. The one-way bearing 511 enables the first transmission gear 51 to drive the second transmission gear 52 to rotate in one direction. When the external drill operates in an incorrect direction, the input gear 42 drives the first transmission gear 51 to rotate in reverse. Due to the one-way rotation function of the one-way bearing 511, the one-way bearing 511 idles at this time, cutting off the transmission of rotation from the first transmission gear 51 to the transmission shaft 5, so that the rope 600 does not rotate, thereby effectively preventing accidents caused by reverse rotation.

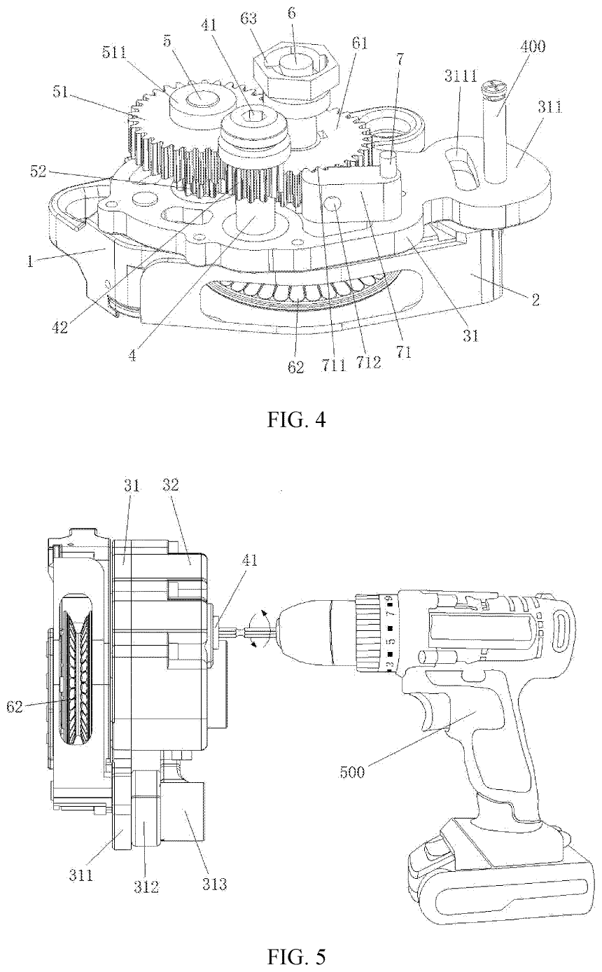

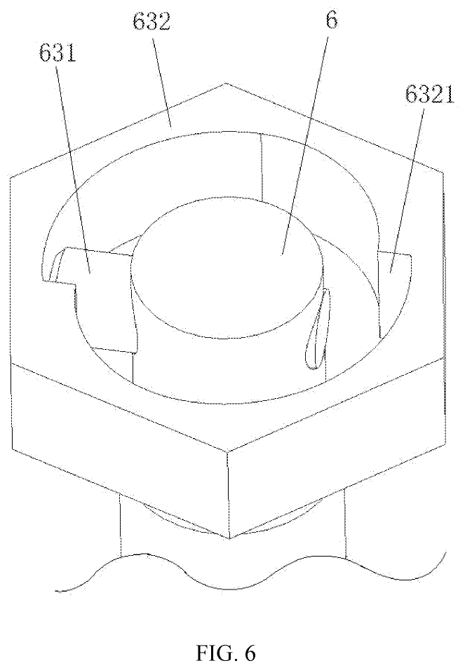

As shown in FIG. 4 and FIG. 6, an anti-reverse device 63 is provided at one end of the output shaft located on the rear side of the base 1. The anti-reverse device comprises a centrifugal pin 631 mounted at one end of the output shaft 6, and a one-way cam plate 632 is arranged on an outer side of the centrifugal pin 631. The one-way cam plate 632 is fixedly mounted to an outer side of the rear housing 32 by fasteners.

The inner wall of the one-way cam plate 632 is provided with two oppositely arranged reverse locking notches 6321. By blocking the centrifugal pin 631 through the reverse locking notches 6321, reverse rotation of the output shaft 6 is effectively prevented, thereby avoiding dangerous accidents caused by reverse rotation of the rope 600 due to wear of the ratchet, and ensuring high safety.

Further, the one-way ratchet 71 is made of a wear-resistant material with high abrasion resistance and is not easily worn. The one-way ratchet 71 is provided with a meshing portion 711 that meshes with the output gear 61. A first spring hole 712 is formed on a side of the one-way ratchet 71 facing away from the output gear 61, and a second spring hole 321 is formed on an inner side wall of the rear housing 32. One end of a return spring (not shown) abuts in the first spring hole 712, and the other end of the return spring abuts in the second spring hole 321. The meshing portion 711 only allows the output gear 61 to rotate in one direction. The return spring constantly urges the meshing portion 711 of the one-way ratchet 71 to engage with the output gear 61. Through the action of the meshing portion 711 and the return spring, when the output gear 61 reverses, the meshing portion 711 of the one-way ratchet 71 blocks the reverse rotation of the output gear 61, thereby preventing reverse rotation of the output shaft 6, the rope wheel 62, and the rope 600, and enhancing the safety of the device.

Further, one end of the front housing 31 is integrally provided with an extension piece 311, and a guide slot 3111 is formed on the extension piece 311. The extension piece 311 is connected with a following block and a handle 313 through a fourth shaft 400. The fourth shaft 400 rotatably connects the handle 313, the following block, and the extension piece 311 of the rear housing 32 together by fasteners. The following block is arranged between the handle 313 and the extension piece 311. The following block is provided with a slider groove 3121 on a side facing the extension piece 311, and is provided with a handle transmission groove 3122 on a side facing the handle 313. The handle 313 is provided with a handle push block 3131 on a side facing the following block. A return torsion spring (not shown) is arranged in the handle transmission groove 3122. The return torsion spring enables the handle 313 to always remain in a clamping state of the rope 600, so as to prevent the handle 313 from being mistakenly rotated to a loosened state of the rope 600, thereby providing certain safety. The handle push block 3131 is rotatably arranged in the handle transmission groove 3122 and abuts against the return torsion spring. The following block is driven to rotate along with the handle 313 through the handle push block 3131 on the handle 313.

One end of the first shaft 100 passes through the guide slot 3111 and extends into the slider groove 3121, and the first shaft 100 serves a guiding function in the guide slot 3111 and the slider groove 3121.

Further, a limiting piece 8 passing through the base 1 is mounted on a side of the gearbox 3 facing the base 1, and a limiting groove matched with the limiting piece 8 is formed on the base 1. The limiting piece 8 comprises a guide post and a protruding disc arranged at one end of the guide post. The guide post serves a guiding function in the limiting groove, and the protruding disc is located on the limiting groove and is flush with the surface of the base 1, thereby providing both guiding and anti-detachment functions.

Further, the base 1 is provided with a guide channel 14 in sliding fit with the output shaft 6. One end of the output shaft 6 on which the rope wheel 62 is sleeved passes through the base 1, and the output shaft 6 serves a guiding function in the guide channel 14. The rope wheel 62 is arranged between the base 1 and the cover plate 2. Three pressure rollers 15 are arranged on the base 1 at one side of the rope wheel 62, and the three pressure rollers 15 are rotatably connected to the base 1. A wear-resistant block 16 is further mounted on the base 1 at one side of the three pressure rollers 15.

When the device bears a load, the three pressure rollers 15 and the rope wheel 62 press the rope 600 to bend, increasing the contact between the rope 600 and the rope wheel 62 and the pressure rollers 15, thereby increasing friction, enabling lifting of a greater load, and providing higher safety.

It should be noted that the number of the pressure rollers can be increased or decreased according to the total weight of the load.

A first outer ring 1001 is mounted on an outer side of the first shaft 100 through a bearing. The first outer ring 1001 and the wear-resistant block 16 are in frictional contact with the rope 600, thereby effectively preventing wear of the device caused by friction of the rope 600.

Further, the base 1 is further provided with a pin hole 11, an inner wall of the pin hole 11 is provided with a stopper, and a spring pin 12 is mounted in the pin hole 11. An outer side wall of the spring pin 12 is provided with a pin groove cooperating with the stopper in a front-rear direction. The cover plate 2 is provided with two locking holes 21 through which the spring pin 12 passes. The spring pin 12 can be pressed back and forth to switch between the two locking holes 21, thereby effectively preventing accidental opening of the cover plate 2.

The base 1 is further provided with a main hole 17 and an auxiliary hole 18. The main hole 17 is used for connecting the device with a buckle, thereby connecting a safety belt or an anchor point, and the auxiliary hole 18 is used for connecting other buckles, facilitating the formation of a pulley system to save effort and lift heavier objects.

### Working Principle

When installing the rope 600, the handle 313 is first rotated away from the device to increase the distance between the pressure rollers 15 and the rope wheel 62. Then the spring pin 12 on the base 1 is pressed, and the cover plate 2 is rotated to expose the rope wheel 62. Next, the rope 600 is placed onto the rope wheel 62. After the rope 600 is installed, the handle 313 is rotated toward the device to reduce the distance between the pressure rollers 15 and the rope wheel 62, so that the pressure rollers 15 and the rope wheel 62 clamp the rope 600. Then the cover plate 2 is rotated back so that the locking holes 21 of the cover plate 2 engage with the spring pin 12.

The present disclosure achieves ascent by driving the drill socket 41 with the external drill 500, and achieves descent by manually controlling the handle 313. When ascent is required, the handle 313 is in a clamped state. The external drill 500 drives the drill socket 41 to rotate forward, and the drill socket 41 drives the input gear 42 on the input shaft 4 to rotate forward. The input gear 42 drives the first transmission gear 51 to rotate in reverse, the first transmission gear 51 drives the second transmission gear 52 on the transmission shaft 5 to rotate in reverse, the second transmission gear 52 drives the output gear 61 to rotate forward, and the output gear 61 drives the rope wheel 62 on the output shaft 6 to rotate forward, so that the rope 600 enters the rope wheel 62 from the first outer ring 1001 and exits the rope wheel 62 from the wear-resistant block 16, thereby enabling the device to lift a person or goods.

When descent is required, the handle 313 is slowly pulled manually, so that the base 1 and the gearbox 3 rotate relative to each other with the second shaft 200 as a pivot, and the angle between the base 1 and the gearbox 3 gradually increases. Meanwhile, the output shaft 6 slides within the guide channel 14, increasing the distance between the rope wheel 62 and the three pressure rollers 15, thereby gradually reducing the friction between the rope 600 and the rope wheel 62 as well as the three pressure rollers 15, thus enabling descent of the rope 600. The operation is flexible and simple, which is conducive to adjusting the working position or enabling rapid escape in case of emergency.

Although the embodiments of the present disclosure have been shown and described, those skilled in the art will understand that various changes, modifications, substitutions, and variations can be made to these embodiments without departing from the principles and spirit of the present disclosure, and the scope of the present disclosure is defined by the appended claims and their equivalents.

What is claimed is:

1. A lifting device, wherein the lifting device comprises a base, wherein a cover plate is hinged to a front side of the base through a first shaft, and a gearbox is hinged to a rear side of the base through a second shaft;
the gearbox comprises a housing, an input shaft is arranged in the housing, one end of the input shaft extends to an outer side of the housing and comprises a drill socket, the input shaft is configured to drive a first transmission gear through an input gear coaxially connected thereto, the first transmission gear is coaxially connected with a second transmission gear, the second transmission gear is configured to drive an output gear, the output gear is in transmission connection with an output shaft, the output shaft extends to the outer side of the housing and is connected with a rope wheel, the rope wheel is arranged between the base and the cover plate, and M pressure rollers are arranged on the base at one side of the rope wheel;
a limiting piece passing through the base is arranged on a side of the gearbox facing the base, an extension piece is arranged at an upper end of the gearbox, the extension piece defines a guide slot, the extension piece of the gearbox is connected with a following block and a handle through a fourth shaft, one side surface of the following block defines a groove and another side of the following block is provided with a handle transmission groove, one end of the first shaft passes through the guide slot and extends into the slider groove, a handle push block is arranged on an inner side of the handle facing the following block, and the handle push block is rotatably arranged in the handle transmission groove and is configured to drive the following block to rotate along with the handle.

2. The lifting device according to claim 1, wherein a return torsion spring is arranged in the handle.

3. The lifting device according to claim 1, wherein a first outer ring is mounted on an outer side of the first shaft through a bearing.

4. The lifting device according to claim 1, wherein the M pressure rollers are rotatably connected to the base, and a wear-resistant block is arranged on the base at one side of the M pressure rollers.

5. The lifting device according to claim 1, wherein a spring pin is arranged on the base, and N locking holes through which the spring pin passes are defined in the cover plate.

6. The lifting device according to claim 1, wherein the limiting piece comprises a guide post and a protruding disc arranged at one end of the guide post, and a limiting groove matched with the limiting piece is arranged in the base.

7. The lifting device according to claim 1, wherein the housing of the gearbox comprises a front housing and a rear housing, and the input gear, the first transmission gear, the second transmission gear, and the output gear are all mounted between the front housing and the rear housing.

8. The lifting device according to claim 1, wherein a one-way ratchet is arranged on one side of the output gear, and the one-way ratchet is pressed against the output gear by a spring.

9. The lifting device according to claim 1, wherein any one of the input gear, the first transmission gear, or the second transmission gear comprises a one-way bearing.

10. The lifting device according to claim 1, wherein one end of the output shaft comprises an anti-reverse device, the anti-reverse device comprises a centrifugal pin mounted at one end of the output shaft, and a one-way cam plate is arranged on an outer side of the centrifugal pin.
